(19) United States
(12) Patent Application Publication
(10) Pub. No.: US 2015/0332252 A1
(43) Pub. Date: Nov. 19, 2015

(54) SYSTEM FOR ACTIVATION OF A DIGITAL CARD

(71) Applicants: Bijan Shahrokhi, Toronto (CA); Andy Lai, Markham (CA); Elliott Atkins, Richmond Hill (CA)

(72) Inventors: Bijan Shahrokhi, Toronto (CA); Andy Lai, Markham (CA); Elliott Atkins, Richmond Hill (CA)

(21) Appl. No.: 14/277,986

(22) Filed: May 15, 2014

(51) Int. Cl. G06Q 20/34; G06Q 20/36; G06Q 30/02

(52) U.S. Cl. CPC G06Q 20/354; G06Q 30/0226; G06Q 20/36

(57) ABSTRACT

The present invention generates a loyalty card, promotion card, membership card, stored value card, payment digital card, or a combination of them. Customers are able to visit a merchant internet site, enter their personal information and receive a digital store card specific for their mobile device and mobile operating system and the merchant. The present invention eliminates the requirement for store specific or aggregated payment and (or) loyalty mobile applications to be stored on the mobile device.

### FIELD OF THE INVENTION

The present invention is a mobile store card for merchants. Using mobile devices with internet access, the present invention generates and/or activates specific digital merchant gift, loyalty and/or payment cards for specific mobile devices and mobile operating systems.

### BACKGROUND OF THE INVENTION

The market for gift, loyalty, payment, membership and promotion cards has continued to increase as it has proven convenient for merchants and for customers. Conventional physical gift and stored value cards tend to be generally purchased and activated at a merchant's physical location. Then the value is added by the merchant using a point of sale system. The stored value cards can generally be reloaded and used multiple times. However, carrying cards from multiple merchants can be cumbersome and inconvenient. Additionally, the customer may find the procedure for checking and viewing the balance and available rewards on such cards difficult.

As mobile payment systems have grown in popularity with the increase in the presence of smart phones, portable tablets and other mobile devices, digital stored value, loyalty, and (or) payment solutions have been implemented on such devices as well. A number of digital payment solutions are currently active in the market with some success. For example aggregated payment or loyalty smartphone applications such as the Square Wallet App or branded white labeled applications such as Freshii's iPhone application are currently available.

The prior art discloses several methods of mobile payments and loyalty card solutions. However, they require downloading and installation of additional applications. Often customers can end up with multiple applications from multiple merchants in addition with the existing digital wallet applications on their mobile device. Additionally, payment solutions that are integrated into the existing digital wallets require that customers find the application, download and then add the merchant card. The above methods can be time consuming and may require the customer to have a large number of similar applications. Moreover, a study performed by Pinch Media explains that use of apps tends to decline drastically after the first day an application is installed and approximately only 20% of users still access the application after the first day. That number declines to 5% after 30 days.

Additionally, specific merchants that want to take advantage of the existing mobile payment systems are sometimes required to create their own applications, which can be costly and time consuming. The present invention provides a means for customers to obtain a digital store card, thereby saving time and making the process of digital payment more accessible and easier.

The present invention also reduces costs for the merchant as it does not require the need for a separate application to be developed. Because there is no separate application, it is less likely to be deleted. It allows the customer's faster access to the digital payment methods that is conveniently stored in the digital wallet of a mobile device.

The present invention can generate promotion cards, loyalty cards payment and stored value cards using a single digital card. A single digital card can serve the purpose of multiple physical cards. More importantly, ease of generation and integration of digital cards by the present invention may further encourage customers to use their mobile devices for purchases.

### SUMMARY OF THE INVENTION

Conventional stored value gift cards, branded credit cards, or loyalty cards require that a physical card be presented at the time of use. Basic information such as the value or balance of the card is not present on the card itself. Platforms built for physical gift cards also have limited functionalities since the user cannot see their balance, rewards programs, payment history, promotions, transactions history, and any data provided by the merchant on the physical card.

With the market reach of mobile smartphones, customers can now use those devices for searching, evaluating, and purchasing different products. Information that is typically contained on mobile phones allows for greater engagement between customers and merchants. Information on mobile phones can lead to more specific targeting of advertisements, for example. Customers may generally be required to download various types of applications from different merchants. This can be time consuming and lead to frustration for the customer.

The present invention provides a digital store card, such as a gift and loyalty card, or real time payment card that has two unique features in comparison to conventional payment cards. The present invention is developed specifically for the mobile platform. As a result, it does not have to take conventional payment method limitations into consideration. Since virtual cards can be presented on a smartphone, they can carry more data and present more information to the user. For example, it can automatically display the balance and payment history, rewards status, and new promotions.

The present invention enables merchants to generate digital mobile store cards to their customers using smartphones' digital wallets. These cards can be used as reloadable cards, loyalty programs, coupons, and actual payment cards. In many cases, the merchant will place a flyer in the store that will describe the benefits of the mobile store card program to the customers. In some cases, the merchant might also offer an incentive to encourage more customers to sign up to the mobile store card program.

The generation of the digital card occurs quickly and easily for the customer as it only requires the customer to visit the merchant's website and enter their personal information. The detection of the mobile device's browser and operating system, as well as the creation of the card is handled by the servers thus making the process much simpler for the customer.

The present invention provides a simple, efficient and novel way of customer and merchant interaction. Customers do not have to download any additional software on their mobile devices, browse through lists of merchants, and make payments through third party applications that require further installation of other applications. Merchants only require a point of sale system that captures interactions between the store and the digital card.

Additionally, unlike existing mobile reward or payment programs the user does not have to download any additional mobile application. The present invention is able to work with the user's existing local digital wallet app (provided by the phone operating system provider) such as the iPhone PassBook or Google Wallet. The advantage to the consumer is that they need only access the merchant website and they do not have to go through the app store for their mobile device in order to obtain the digital card.

The present invention allows for tracking of individual customer purchasing data, and allows the merchant to offer various reward programs customized to suit the user's engagement level and spending habits, and pushes promotional coupons to the user's smartphone without the need to download any additional applications or click on any links by the user.

The present invention can also integrate aspects of membership cards. Merchants can add loyalty rewards programs and other benefits that can encourage customer involvement.

The present invention in other embodiments can be linked to a credit card, bank account, or other account containing a balance in order to offer real time or stored value payments at the time of purchase.

All this will result in faster customer service, higher sales volume, and more environmentally friendly business operation. It allows for more data to be available to customers about merchants' offers and their purchasing history. For merchants, the present invention allows for tracking of customer purchases, direct targeting of promotions and less overhead and costs when compared to conventional application development.

### BRIEF DESCRIPTION OF THE DRAWINGS

Embodiments herein will hereinafter be described in conjunction with the appended photos provided to illustrate and not to limit the scope of the claims, wherein like designations denote like elements, and in which:

FIG. 1 (a-b) shows an overview of a purchasing process as performed by the conventional method; FIG. 1 (c) shows an overview of a purchasing process as performed by the present invention;

FIG. 2 shows a summary of how a zero-value digital card is created; and

FIG. 3 shows how a transaction occurs with the present invention.

### DETAILED DESCRIPTION OF THE DRAWINGS

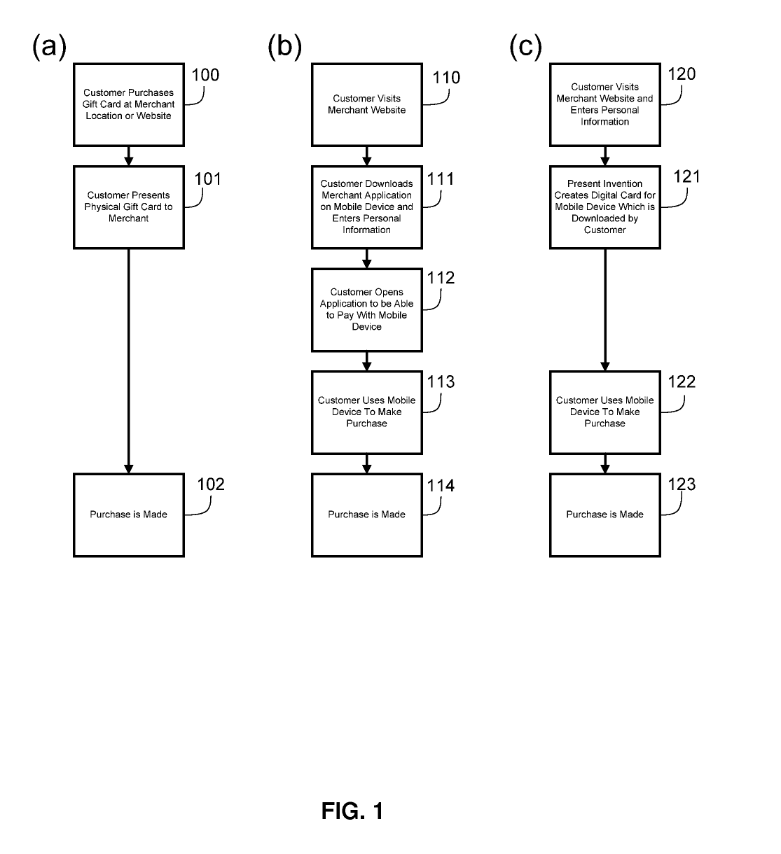

As shown in FIG. 1 (a), conventional payment cards require the customer to make a purchase or order for the card 100. The card has to be in the customer's possession at the time of purchase. The card is presented and swiped at a point of sale terminal 101 and the amount of purchase is withdrawn from the value in the card 102 or account. A customer usually receives information about the balance on the card on the receipt. Since each merchant requires their own stored value cards or payment solutions to be used, a customer may have multiple cards at any one time and may lose track of such things as the balance or the actual location of the card.

As shown in FIG. 1(b), conventional mobile payment and loyalty systems require that the user download a specific merchant software application manually on their mobile device. Once a user is made aware of the existence of a mobile digital payment system by visiting a merchant's website 110 or by visiting their phone's application store, the user may download an application 111 specific to that merchant. The customer then has to open the application and enter their personal information 112 in order to set up payment through their mobile device. The customer is then able to use their mobile device to make purchases 113. A purchase using a mobile device 113 can then be made when a user is online or when a user is at a physical merchant location 114.

FIG. 1 (c) is an overview of how the present invention performs the action of obtaining a digital store card. The customer can visit the merchant's website and enter their personal information 120. The present invention will then generate and upload a digital store card on the customer's mobile device 121. The customer is then able to use their mobile device to make a purchase 122 at the merchant's physical location or website 123.

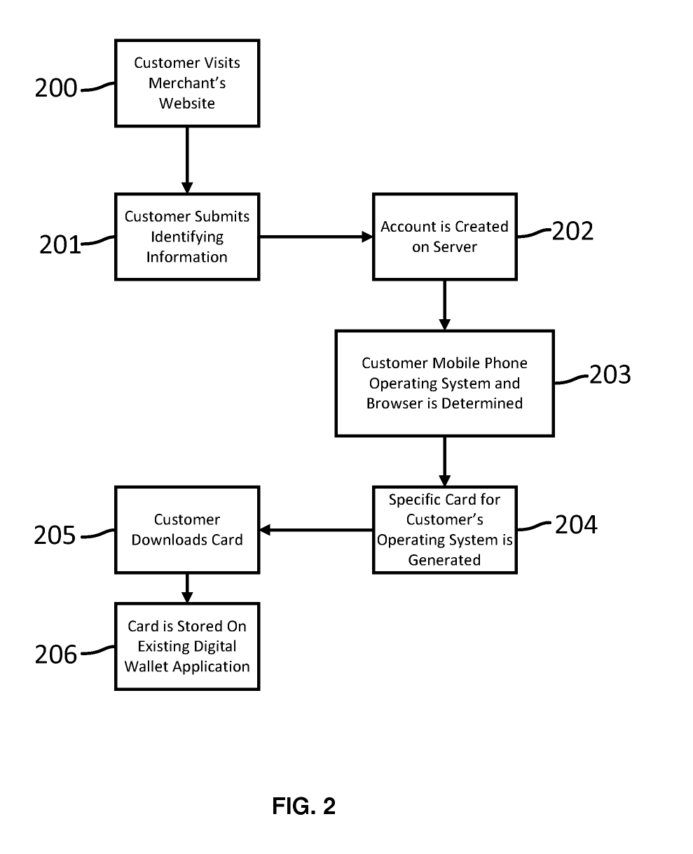

FIG. 2 shows the details of the process by which the present invention generates and stores the digital payment card on the customer's mobile device. The customer may visit a merchant's website with their mobile device and enter their information 201 on a section of the merchant's website related to offering the digital payment card. The phone's browser communicates to the server and provides the user-agent parameters which may include the phone device mobile browser and operating system and an account is created 202. The server determines the browser and its operating system 203. The server creates a mobile store card for the specific merchant for that particular smartphone mobile operating system 204 and digital wallet. The generated digital card can be added by the consumer on their mobile device 205 and saved under the digital wallet app 206. The present invention is also capable of generating a zero-value digital store card on the mobile device. For example, in one embodiment of the present invention, a customer with an Apple iOS operating system will receive an iPhone PassBook file compatible with Apple's iPhone PassBook. As such, there is no need for downloading an additional merchant specific application and the customer onboarding process is made simpler.

In the case when stored value functionality is enabled, a zero-value digital store card may be generated or a customer may load a monetary value using a number of methods. Digital card loading can be done through a POS terminal using cash, credit or debit card at the merchant's physical location. Loading of the digital store card can also be done online through a website and a credit card. In that case, the customer can visit the merchant portal that is set up by present invention and choose the monetary value that he/she will assign to the digital store card. In either method, the monetary value is automatically loaded onto the customer's mobile device once the payment is completed.

The mobile device can be any cellular device that contains software and hardware that allow it to communicate with other devices on a cellular network, to communicate data wirelessly with the payment service provider, or to be able to access the Internet for data communication. The data communication can occur through already existing means and protocols such as: wireless networks (Wi-Fi), Transmission Control Protocol/Internet Protocol (TCP/IP), wireless cellular networks (General Packet Radio Service (GPRS), Enhanced Data Rates for GSM Evolution (EDGE), Code division multiple access (CDMA), Universal Mobile Telecommunications System (UMTS), and 3G or 4G).

Merchants participate in the mobile payment system by having such appropriate infrastructure such as (Point-Of-Sale) POS equipment system capable of reading multiple forms visual and non-visual digital card identifiers stored on a mobile device. Other embodiments of the inventions can allow payment to be made using Near Field Communication (NFC), RFID and other methods.

The present invention allows for it to be directly linked with a user's bank account. In this embodiment, the present invention operates by mediating transactions between the user's bank account and the merchant. Other types of accounts are also possible to use with the present invention. Instead of a bank account, a user may use a PayPal account, or other services such as Dwolla. Additionally, the present invention may be used for any other internet accessible monetary account which has value such as Bitcoin or other variants of alternative currencies.

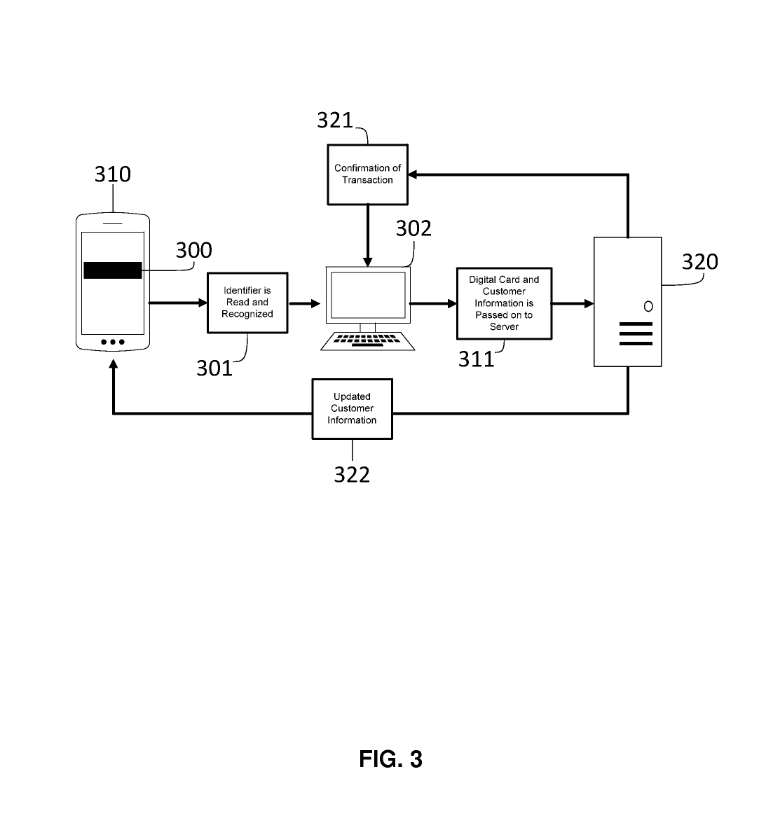

FIG. 3 shows one embodiment of the purchasing process as performed by the present invention. Initially, the customer instructs the merchant that he/she wishes to use a digital store-card. A payment system that is integrated with the POS system or payment terminal 302 will recognize 301 the identifier 300 generated by the digital card on the mobile device 310. Other methods of payment such as NFC and iBeacons can also be utilized as long as the appropriate infrastructure is present. Card and customer information 311 will be sent to the server 320 and the server 320 will approve or reject the transaction. Confirmation of the transaction 321 will be sent to the merchant terminal 302 and updated information 322 such as the digital card information, transaction history and other information relating to the purchase. Loyalty program information will be pushed to the mobile device 310. This step allows the customer to keep track of their payment history, loyalty rewards and coupons on their mobile phone 310.

The identifier 300 that is displayed on the mobile device 310 is used to transmit the digital card information to the merchant. Embodiments of the identifier can include but are not limited to 2D barcodes such as: Aztec code, a PDF417 barcode, a QR code, a 16 digit barcode, a data matrix code, a trillcode, and a shotcode. Other non-visual embodiments of the identifier can include but are not limited to NFC tags, RFID tags or Apple iBeacon tags and similar.

The foregoing is considered as illustrative only of the principles of the invention. Further, since numerous modifications to the Mobile Store Card System and changes could be made by those skilled in the art that have an understanding of this invention, it is not desired to limit the invention to the exact construction and operation shown and described, and accordingly, all suitable modifications and equivalents may be resorted to falling within the scope of the invention.

With respect to the above description, it is to be realized that the optimum relationship for parts of the invention with regard to size, shape, form, materials, function and manner of operation, assembly and use are deemed readily apparent and obvious to those skilled in the art, and all equivalent relationships to those illustrated in the drawings and described in the specification are intended to be encompassed by the present invention.

What is claimed is:

1. A method to activate a digital card in a digital wallet application of a mobile device, set method comprising:
a. collecting information on a merchant through a base internet server;
b. developing a set of merchant specific web pages on said base server using the collected merchant information;
c. creating an account for a customer and collecting customer information including information on customer mobile device operating system and browser through said set of merchant specific web pages;
d. determining the operating system of said mobile device;
e. generating a digital card based on said operating system of said mobile device;
f. transferring said digital card to the digital wallet application of said mobile device; and
g. connecting said digital card to said merchant through said base internet server by validating a specific identifier on said digital card.

2. The method to activate a digital card for a mobile device of claim 1, wherein said digital card being a payment card, a stored value card, a loyalty card, a promotional card, or a combination thereof assigned to said merchant.

3. The method to activate a digital card for a mobile device of claim 1, wherein said digital wallet application being a Google wallet application, or an iPhone PassBook application or a digital wallet application provided by the operating system or the mobile device manufacturer.

4. The method to activate a digital card for a mobile device of claim 1, wherein said specific identifier being selected from the group consisting of a 2D barcode, a Near Field Communication, and iBeacons.

5. The method to activate a digital card for a mobile device of claim 1, wherein said payment information being selected from a group consisting of a credit card, a bank account, a Dwolla account, a Bitcoin account, a PayPal account, and an internet accessible monetary account.

6. The method to activate a digital card for a mobile device of claim 1, wherein said specific identifier providing a real time transaction.

7. A system for activation of a digital card in a digital wallet application of a mobile device comprising:
a. a base internet server having a processor and being configured to store a merchant and a customer information;
b. a set of web pages designed on said base server to direct a customer to enter customer information and a payment information;
c. said processor configured to create an account for said customer;
d. said base internet server having a means to communicate with said mobile device and merchant;
e. said processor configured to determine the operating system of said mobile device;
f. said processor configured to generate said digital card based on said operating system of said mobile device;
g. said digital card being stored on said mobile device; and
h. said digital card configured to display a specific identifier on said mobile device to communicate with said merchant point of sale.

8. The system for activation of a digital card of claim 7, wherein said digital card being a payment card, a stored value card, a loyalty card, a promotional card, or a combination thereof assigned to said merchant.

9. The system for activation of a digital card of claim 7, wherein said digital wallet application being a Google wallet application, or an iPhone PassBook application or a digital wallet application provided by the operating system or the mobile device manufacturer.

10. The system for activation of a digital card of claim 7, wherein said specific identifier being selected from the group consisting of a 2D barcode, a Near Field Communication and iBeacons.

11. The system for activation of a digital card of claim 7, wherein said payment information being selected from the group consisting of a credit card, a bank account, a Dwolla account, a Bitcoin account, a PayPal account, and an internet accessible monetary account.

12. The system for activation of a digital card of claim 7, wherein said specific identifier providing a real time transaction.
